(19) United States
(12) Patent Application Publication
(10) Pub. No.: US 2021/0314410 A1
(43) Pub. Date: Oct. 7, 2021

(54) On device device driver

(71) Applicant: Emile Michel Hobo, Enschede (NL)

(72) Inventor: Emile Michel Hobo, Enschede (NL)

(21) Appl. No.: 14/618,346

(22) Filed: Feb. 10, 2015

(51) Int. Cl. H04L 29/08; H04L 29/06

(52) U.S. Cl. CPC H04L 67/16; H04L 69/03

(57) ABSTRACT

I, Emile Michel Hobo, born Jul. 5, 1980 in The Hague, The Netherlands, sole inventor, hereby request a patent for the design of an On Device Device Driver, which through establishing a connection to a device grants instant use of that device.

Description: Embed the device driver as a Data Type Definition model (DTD) on a chip or memory card. The DTD describes the protocols and the format of the filetypes associated with the device in order to communicate with it, meaning no external driver is needed anymore. The chip or memory card is then inserted in the device, either permanently or temporarily. As soon as you connect the device to another device, this other device downloads the device description and driver from the device in order to use it.

Category: Y04—INFORMATION OR COMMUNICATION TECHNOLOGIES HAVING AN IMPACT ON OTHER TECHNOLOGY AREAS.

1. The “On Device Device Driver” of this claim is a model, comprising a description of the protocols and/or file types for communication with this device, wherein the model is located on said device to be transmitted to any other device that connects to it in order to identify the means of communication with said device.
